(19) United States
(12) Patent Application Publication
(10) Pub. No.: US 2021/0339478 A1
(43) Pub. Date: Nov. 4, 2021

(54) Arranging Calibration Objects in a Build Volume

(71) Applicant: Hewlett-Packard Development Company, L.P., Spring, TX (US)

(72) Inventors: Sergio GONZALEZ MARTIN, Sant Cugat del Valles (ES); Manuel FREIRE GARCIA, Sant Cugat del Valles (ES); Jordi SANROMA GARRIT, Sant Cugat del Valles (ES)

(73) Assignee: Hewlett-Packard Development Company, L.P., Spring, TX (US)

(21) Appl. No.: 17/252,321

(22) PCT Filed: Jan. 23, 2019
(86) PCT No.: PCT/US2019/014741

§ 371 Date: Dec. 15, 2020

(51) Int. Cl. B29C 64/393; B29C 64/20; G06K 15/02

(52) U.S. Cl. CPC B29C 64/393; B33Y 50/02; G06K 15/027; B29C 64/20

(57) ABSTRACT

An apparatus has a processor and a machine-readable storage medium storing machine-readable instructions executable by the processor. The machine-readable instructions cause the processor to, upon obtaining an indication that a calibration of a 3D printing machine is to be performed, arrange user calibration objects to be printed and calibration objects to be printed and to be used in the calibration in a virtual build volume. Arranging calibration objects in the virtual build volume comprises arranging the calibration objects at print job specific locations reserved for calibration objects and/or replacing user objects with calibration objects.

### BACKGROUND

3D printing systems may be calibrated by printing calibration objects, measuring properties of the printed calibration objects, and adjust subsequent printing using the measured properties. Adjusting subsequent printing may include modifying an object model. For example, if it is known that an object printed in a certain location of a build chamber of the printer has different dimensions when compared to the original object model, the object model may be modified such that upon printing it has the dimensions of the original object model.

### BRIEF DESCRIPTION OF THE DRAWINGS

Examples will now be described, by way of non-limiting examples, with reference to the accompanying drawings, in which:

FIG. 1 is a simplified illustration of a 3D printing system according to one example;

FIG. 2 is an illustration representing a virtual build volume in which user objects and calibration objects are arranged according to an example;

FIG. 3 is an illustration representing the allocation between a selectable calibration level and the number of calibration objects to be arranged in a virtual build volume according to an example;

FIG. 4 is an illustration according to an example of a virtual build volume in which user objects and calibration objects are arranged, wherein the calibration objects are arranged at locations being different from previous calibration object locations;

FIG. 5 is a flow diagram outlining a method of operating a 3D printing system comprising a proposed apparatus according to an example;

FIG. 6 is a flow diagram outlining a method of operating a 3D printing system comprising a proposed apparatus according to an example.

### DETAILED DESCRIPTION

The behavior of 3D printing systems may vary during usage of the 3D printing system over time. Calibration may include changing parameters of the 3D printing system itself to generate an object with desired dimensions. Calibration may include modifying an object model to generate an object with desired dimensions. For example, an object to be printed in a certain location of a build chamber of the 3D printing system may have different dimensions when compared to the original object model and the object model to be printed with the 3D printing system may be modified such that upon printing the object has the dimensions of the original object model. The usage of 3D printing system may make it recommendable to recalibrate certain aspects of the 3D printing system from time to time. Such calibrations or recalibrations may be made with a pre-determined periodicity. Some calibrations may just ask a user to trigger certain operations on the 3D printing systems, for example aligning a print head used to print an liquid agent. However, other operations, such as the generation of an object model calibration model to correct for thermal non-uniformities in a real build chamber or build volume of a 3D printing system, may comprise printing certain content in relevant positions from time to time, i.e. printing calibration objects. Upon printing the calibration objects, properties of the printed objects may be measured and a new calibration model may be generated using the measured properties. The calibration model describes parameters for different regions of the printing zones. The parameters in the calibration model may then be used to adjust parameters, such as the geometry, of an object model to be printed by the 3D printing system in a subsequent printing process.

To handle thermal non-uniformities across the build chamber of the 3D printing system the build chamber may be calibrated with the calibration model which represents how parts may be geometrically transformed during a 3D printing process depending on different part characteristics, such as their position within the build chamber. Stating differently, the calibration model may characterize thermal non-uniformities across the build chamber and may allow an object model to be geometrically modified such that, upon printing, the modified object model cause generating of an object that has dimensions more closely matching the dimensions of the original object model. Thus, the calibration model may describe for each position of the build chamber, i.e. of a build volume, a geometric transformation parameter. A geometric transformation may comprise a shrinkage of portions of the object, e.g. due to a cooling process, or may comprise a growing of portions of the object, e.g. due to thermal bleed. To properly compensate this geometric transformation, the calibration model is to be updated periodically as the printer conditions may vary over time.

Examples of the present disclosure relate to an approach which permits printing of calibration objects to be used to generate a calibration model, for example, to correct for the effects of thermal non-uniformities in a build chamber of a 3D printing machine, in an effective manner. In examples, a user is informed about a pending periodic calibration, and is then allowed to create print job data containing the calibration objects which still lets him to insert user content in the non-used space. Also, it allows the user to submit print job data and then let the printer automatically substitute, if appropriate, certain objects with objects for calibration. Upon printing the calibration objects using print job data prepared in this manner, a new calibration model may be generated or an existing calibration model may be updated. Examples provide a mechanism to inform a user about periodic times for calibrations and a workflow to prepare print job data to achieve printing of the calibration objects.

The term calibration object means a 3D object which is to be printed for calibration purposes. The term user object means a 3D object which is to be printed to produce a specific object or product in response to a user submission. The term virtual build volume means that the objects are arranged virtually in a build volume before the objects are actually printed in the real build chamber of the 3D printing system.

3D printing systems may print objects, such as calibration objects and/or user objects, by applying fluids to layers of build material and applying heat in order to fuse the build material at locations where fusing agent is placed. The build material may include powder. In examples, the build material includes short fibres that may have been cut into short lengths from long strands or threads of material. The build material may include plastics, ceramic, and metal powders and powdery materials. In examples, the 3D printer may use chemical binder systems or may use metal type 3D printing. The present disclosure is not limited to the specified 3D printing systems disclosed herein.

According to one example, a suitable fusing agent may be an ink-type formulation comprising carbon black, such as, for example, the fusing agent formulation commercially known as V1Q60A “HP fusing agent” available from HP Inc. In one example, such a fusing agent may additionally comprise an infra-red light absorber. In one example, such an ink may additionally comprise a near infra-red light absorber. In one example, such a fusing agent may additionally comprise a visible light absorber. In one example, such an ink may additionally comprise a UV light absorber. Examples of inks comprising visible light enhancers are dye based colored ink and pigment based colored ink, such as inks commercially known as CE039A and CE042A available from HP Inc. According to one example, a suitable de-tailing agent may be a formulation commercially known as V1Q61A “HP de-tailing agent” available from HP Inc. According to one example, a suitable build material may be PA12 build material commercially known as V1R10A “HP PA12” available from HP Inc.

While a printed object is cooled, it may undergo a geometrical transformation which may depend on how the temperature of the objects varies and/or may depend on the build materials used for printing the objects or products. For example, the temperature of the objects may vary because of their geometry.

Therefore, it may be recommendable to scale input models of the objects to be printed before printing them in an attempt to compensate the geometric transformation. However, the geometric transformation of the objects may not be equal for all objects in the real build chamber of the 3D printing system due to thermal non-uniformities across the build chamber of the 3D printing system. To overcome this, the geometric transformation may be compensated using the position of the object in the build chamber, and may be other part descriptors, such as volume, surface or density. To this end, the printer may have a calibration file which models the behavior of the objects across the build chamber. The calibration file includes the calibration model or different calibration models for different profiles. In examples, different profiles may define different printer settings to be used in printing.

The calibration file may be initially generated, for example, upon delivery of a new 3D printing system. Currently a calibration model is generated by executing print job data including just calibration objects. Such generation of the calibration model is initially performed when a new 3D printing system is installed. The calibration file may become inaccurate as the printer is being used over time. To ensure dimensional accuracy of 3D printed objects it is valuable to update the calibration file on a periodic basis. To update the calibration file, new calibration objects are to be printed and measured. However, it may be inconvenient to users to periodically have to print a whole print job of calibration objects as this prevents the users from using the 3D printer to print user objects. The present disclosure provides a way to keep the originally generated calibration model up-to-date, but printing calibration objects in specific build chamber locations at different times without having to print a whole print job of calibration objects. The calibration objects printed according to the present disclosure may be measured and their details entered into the printer to allow the calibration model to be updated.

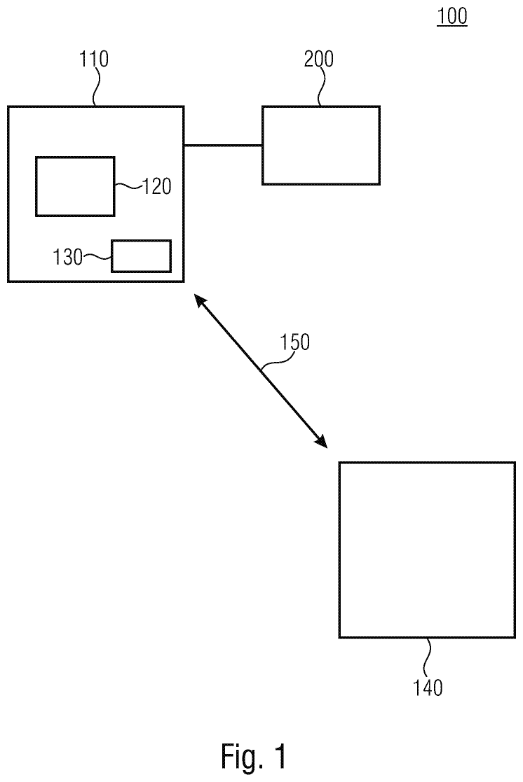

Examples of the present disclosure are now described with reference to FIGS. 1-6.

Examples of the present disclosure provide an apparatus to arrange calibration objects and user objects in a virtual build volume, wherein the apparatus may be a component of a 3D printing system. The apparatus comprises a processor and a machine-readable storage medium storing machine-readable instructions executable by the processor. The machine-readable instructions comprise instructions to cause the processor to, upon obtaining an indication that a calibration of a 3D printing machine is to be performed, arrange user objects to be printed and calibration objects to be printed and to be used in the calibration in a virtual build volume. Arranging the calibration objects in the virtual build volume comprises arranging the calibration objects at print job specific locations reserved for calibration objects and/or replacing a user object with a calibration object. The reserved locations may be reserved for calibration objects by a pre-print application, thereby preventing a user or an automated object packing application from placing a user object in the reserved locations. The reserved locations may change from one print job to another. Arranging the user objects and the calibration objects in the same build volume permits printing the user objects and the calibrations objects within the same print job and, therefore, expenditure of time involved in performing the calibration may be saved.

Referring now to FIG. 1, there is shown a simplified illustration of a 3D printing system 100 according to an example. The 3D printing system 100 comprises a 3D printing machine 140, an interface 200 and an apparatus 110 to arrange calibration objects and user objects in a common build volume as just described. The apparatus 110 comprises a processor 120 and a storage medium 130. As indicated by a bidirectional arrow 150, the apparatus 110 may be coupled with the 3D printing machine 140 to communicate with the 3D printing machine. Coupling 150 may be achieved by wired coupling or wireless coupling. The apparatus may be to send print job data to the printing machine 140 via coupling 150. The print job data may describe an arrangement of user objects and calibration objects in the virtual build volume. Generally, the virtual build volume corresponds to the real build chamber of the 3D printing machine. In examples, there may be a mapping between the virtual build volume and the real build chamber of the 3D printing machine 140. The term virtual is used to indicate that the objects are virtually arranged in the build volume by the apparatus before the same are actually arranged in the real build chamber by printing the objects using the 3D printing machine 140. Upon sending the print job data to the 3D printing machine 140, the calibration objects and the user objects are printed during execution of one and the same print job. Stating differently, the calibration objects and the user objects are printed during the same build process. Thus, some degree of calibration may be performed during normal printing, i.e. during printing of user objects.

The 3D printing machine 140 is to perform the print job and comprises the components to build the objects, i.e., user objects and or calibration objects, using the respective build material and/or printing fluids from which the objects are to be formed. The 3D printing machine 140 receives the print job data from the apparatus 110 and prints the objects according to the arrangement of user objects and calibration objects indicated in the print job data.

In examples, the 3D printing system 100 may be in the form of a printer, in which the apparatus 110 is integral with the 3D printing machine 140. In examples, the apparatus 140 comprises an interface 200, such as a display combined with a touchscreen. In other examples, the interface 200 may be realized differently, such as by a device for voice input or a keyboard allowing a manual input. In examples, the interface 200 may be a user interface permitting a user to arrange the objects to be printed in the virtual build volume. In other examples, apparatus 110 may be separate from the 3D printing machine and may be formed by a computer, such as a desktop computer, a laptop, a tablet or a personal digital assistant, wherein the interface 200 may be formed by any suitable interface associated with the computer. In other examples, apparatus 110 may be part of a web-based printing system, in which a user may communicate with the apparatus via a web service.

The apparatus 110 may obtain the indication that calibration of the 3D printing machine 140 is to be performed. The indication may be obtained from the printing system informing the apparatus that a calibration is to be performed. The indication may be presented to the user via interface 200. The indication may be obtained if a predetermined condition is fulfilled. The predetermined condition may be an expiration of a predetermined time period and/or the execution of a predetermined number of print jobs. In examples, the indication is obtained periodically. In examples, the indication may be triggered by a user such as by using a user interface.

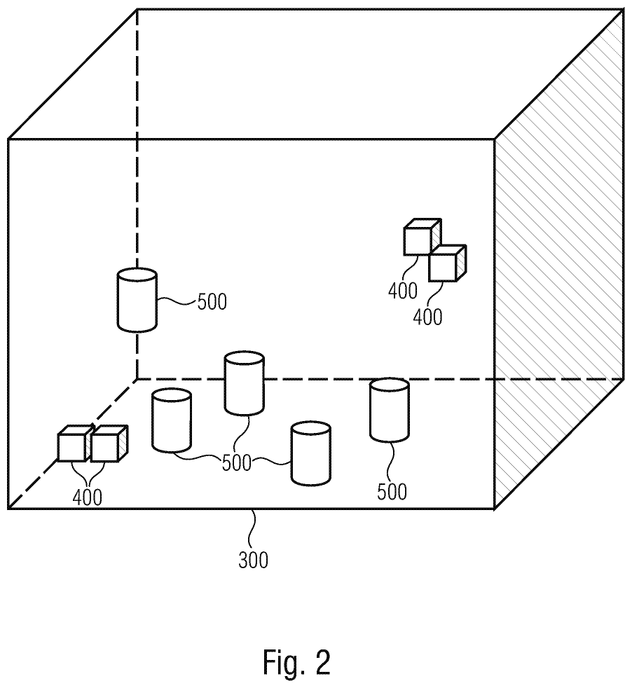

FIG. 2 shows an example of a virtual build volume 300 of a 3D printing machine. According to examples, machine-readable instructions stored on memory 130 cause the processor 120 to generate print job data describing the arrangement of user objects 500 and calibration objects 400 in the virtual build volume 300 and to submit the print job data to the 3D printing machine 140. In the example of FIG. 2 five user objects 500 and four calibration objects are virtually arranged in the build volume 300. Thus, according to examples, if calibration is to be performed, calibration objects 400 may be added automatically into the virtual build volume and may be printed along with user objects during the same build process, such as using the same print job data. The reserved locations allocated to the present print job data may be used for automatically adding calibration objects 400. The reserved locations may be occupied with calibration objects depending on a level of calibration a user has chosen.

In examples, an initial printer calibration model may be performed at installation of the printer by printing the whole build chamber full of calibration objects. In order to maintain the accuracy of the calibration model over time, the 3D printing machine 140 is allowed to print a small number of calibration objects within a user print job. In order to ensure that the calibration model is kept up-to-date, the calibration objects may be printed at different reserved locations in different print jobs, so that after a certain number of completed print jobs, a full set of calibration objects may have been printed. Thus, calibration of the whole build chamber may be kept up to date by distributing calibration objects between different print jobs.

In examples, an automatic replacement of user objects with calibration objects may be performed. Upon obtaining an indication that a calibration is to be performed, the apparatus may reserve locations of the build chamber for calibration objects. The apparatus may reserve different locations of the build chamber for calibration objects in different print jobs so that, after executing a specific number of print jobs, a calibration object has been printed at each location of the build chamber. Upon receiving print job data which includes user objects and which does not include calibration objects, the apparatus 110 may ask the user, before starting the printing operation, if he wants to replace some of the user objects by calibration objects if user objects are located at a location where a calibration object is to be printed. This may be achieved using a modal dialog, in which the user may select between performing calibration by adding calibration objects and not performing calibration. If the user affirms that a calibration is to be made, the machine-readable instructions may cause the processor 120 to automatically replace user objects 500 by calibration objects 400 in the manner described above. Upon doing so, new print job data may be generated and submitted to the printing machine 140. The newly generated print job data replaces the initial print job data. The printing job may then be executed according to the instructions included in the newly generated print job data in order to print the calibration objects and the user objects included in the newly generated print job data.

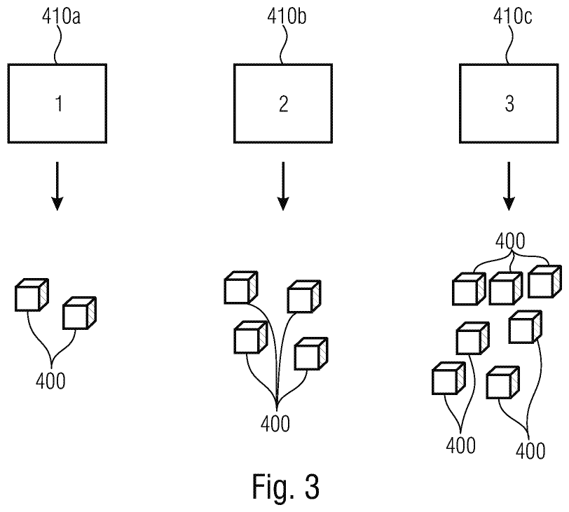

In examples, the machine-readable instructions may cause the processor 120 to select a number of calibration objects 400 depending on a level of calibration and to arrange calibration objects 400 corresponding to the selected number of calibration objects 400 in the virtual build volume 300. In examples, the level of calibration may be indicated by an integer. In an example, as shown in FIG. 3, a first level of calibration 410a, such as indicated by the integer 1, may define a low level of calibration, in which a low number of user objects 500 are replaced by calibration objects 400. A second level of calibration 410b, such as indicated by the integer 2, may define a medium level of calibration 410, in which a higher number of user objects are replaced when compared to the first level of calibration 410a. A third level of calibration 410c, such as indicated by the integer 3, may define a high level of calibration, in which a higher number of user objects are replaced when compared to the second level of calibration 410b. The level of calibration may be user selectable. Depending on the level of calibration, a certain amount of user objects 500 is replaced by calibration objects 400. In examples, initial print job data not including calibration objects may be changed by such a replacement. In other examples, such a replacement may be made when originally preparing print job data.

In examples, a low level of calibration 410a may define that two to three calibration objects 400 are to be arranged in the virtual build volume 300. In examples, a medium level of calibration 410b may define that ten to twenty calibration objects 400 are to be arranged in the virtual build volume 300. In examples, a high level of calibration 410c may define that thirty to forty calibration objects 400 are to be arranged in the virtual build volume 300. Of course, other numbers and other graduations are possible. Thus, in examples, depending on the level of calibration chosen more or less calibration objects will be added to the virtual build volume 300.

In examples, if a user selects to print calibration objects 400, the machine-readably instructions cause the processor to select some regions in the build chamber, i.e. the printing zone, in which the calibration objects 400 are to be placed. The regions where user objects are to be printed may be defined by a bounding box or bounding boxes. The regions where calibration objects are to be printed may also be defined by respective bounding boxes. All user objects 500 which intersect with a bounding box of the calibration objects 500 may be removed from the virtual build volumer. In examples, arranging the user objects may be done taking into account the reserved locations for calibration objects. In case that identified regions for printing calibration objects 400 do not intersect with bounding boxes for printing user objects 500, the calibration object 400 may just be added without removing a user object. A list of user objects 500 removed from the virtual build volume may be generated and may be reported to the user. The user may then prepare following print job data including the removed user objects 500.

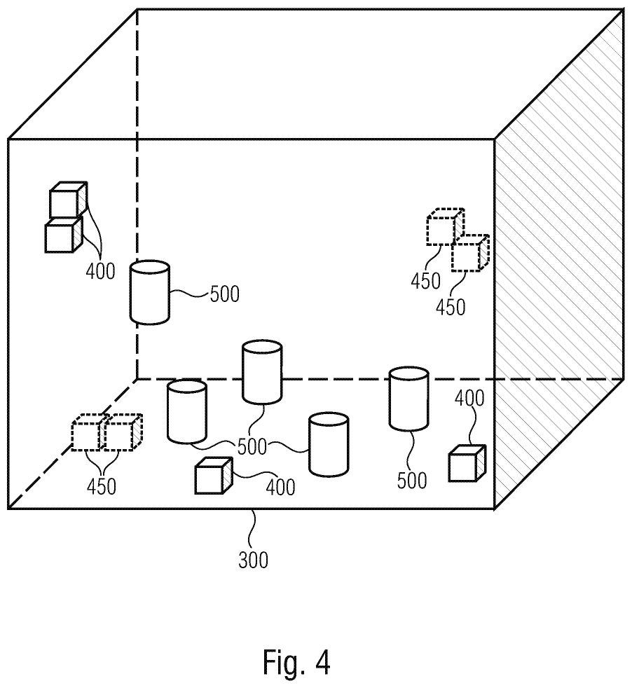

In examples, the machine-readable instructions may cause the processor 120 to identify regions of the virtual build volume 300 where calibration objects 400 are to be arranged to be different from regions of the virtual build volume 300 at which calibration objects 400 have been arranged in a previous calibration of the 3D printing machine. Referring to FIG. 4, calibration objects used in a previous calibration are indicated by reference number 450 and calibration objects of the current arrangement are indicated by reference number 400. Arranging calibration objects in this manner allows for a calibration of the entire build chamber 300 over a plurality of calibrations performed over time. Thus, all regions of the build chamber may be calibrated and, therefore, thermal non-uniformities across the build chamber may be prevented.

In examples, the machine-readable instructions may cause the processor 120 to identify regions of the virtual build volume 300, in which a print quality is reduced. A reduced print quality may be determined by a user or may be determined automatically. A reduced print quality means that the printing outcome deviates from the expected outcome. Calibration objects 400 may be printed is such regions so that recalibration in such regions is possible in order to achieve a better print quality. The identified regions may comprise a subset or all of the regions in which calibration objects are arranged in the virtual build volume. For identifying the regions with reduced print quality, properties of previously printed objects may be measured. The measured property may be compared to a predetermined property being for example stored in the storage medium 130. The property may be a dimension of features of the object.

In examples, the apparatus 110 comprises a user interface. The user interface permits a user to decide whether calibration of the 3D printing machine 140 is to be performed, and/or to select a level of calibration 410, and/or to identify regions of the virtual build volume 300 where calibration objects 400 are to be printed. Thus, the user may control if a calibration is to be performed and/or which level of calibration 410 is to be performed. Moreover, the user may be in a position to identify regions of the virtual build volume corresponding to a real build chamber of the 3D printing machine 140, where calibration is to be performed. Thus, the user is in a position to control or modify the performance of the 3D printing system 100 by selecting regions of the build chamber to be calibrated appropriately.

In examples, the indication that a calibration is to be performed may be obtained dependent on a calibration period setting associated with the 3D printing machine 140. Such a calibration period setting may define a certain period of time, wherein, when the certain period of time has surpassed, calibration is recommended. A calibration alert may be generated and raised upon surpassing the certain period of time. The calibration period setting may take into account the level of usage of the 3D printing system 100. For example, the period of time may be shorter if the 3D printing system 100 is used less often and may be higher if the 3D printing system 100 is used more frequently. The calibration period setting may define a periodic recalibration. Each time a recalibration time defined by the calibration period setting is reached, an indication may be presented to a user, such as by providing a dialog on a user interface.

In examples, the 3D printing system 100 may have a calibration period setting, which may be stored in the storage medium of the printing system 100 and which may be different for every profile. The calibration period setting may determine the recommended period of time between calibrations. Then, when the period of time is surpassed, the 3D printing system 100 may raise an alert visible from a front panel of the interface of the printer. In examples, an alert may be raised in a control application through a web service, such as in a control application command center.

In examples, to update the calibration, a limited set of points, i.e., regions, from the calibration model may be selected which are to be calibrated. The machine-readable instructions may cause the processor to pseudo-randomly select these positions taking into consideration also previous calibrations so that the whole build chamber of the 3D printing machine may be covered by subsequent calibrations. The mentioned profile may consider how often the 3D printings system 100 is used for printing user objects 500. The more often the 3D printing system is used the less often a calibration may be recommendable.

Examples provide a 3D printing system 100 as shown in FIG. 1. The 3D printing system 110 comprises a 3D printing machine 140 and the apparatus 110 disclosed herein. The 3D printing machine 140 executes a build process to print the user objects 500 and the calibration objects 400 during the same build process. In doing so, extra time for performing calibration separately from printing user objects may be saved. A property of the printed calibration objects 400 may be measured and the calibration model may be updated using the measured property. The property measured may be a property indicative of the geometric transformation behavior of the calibration object.

Examples of the present disclosure provide a method to arrange user objects and calibration objects within a virtual build volume. Upon obtaining an indication that a calibration of a 3D printing machine is to be performed, user objects to be printed and calibration objects to be printed and to be used in the calibration are arranged in a virtual build volume. The calibration objects are arranged in the virtual build volume at locations reserved for calibration objects and/or the calibration objects replace user objects. The locations reserved for calibration objects may change between print jobs, i.e. may be print job specific. The calibration objects may be arranged at locations being reserved for calibrations, wherein the a user may be prevented from arranging user objects at the reserved locations. In case a user object is arranged in a reserved location, the user object may be replaced with the calibration object automatically.

In examples, the method may comprise generating print job data describing the arrangement of user objects and calibration objects in the virtual build volume, and submitting the print job data to the 3D printing machine. Such print job data may comprise first print data describing the user objects and second print data describing the calibration objects. Furthermore, the method may comprise executing a build process by the 3D printing machine using the print job data to form the user objects and the calibration objects during the same build process. As the calibration objects may be printed together with the calibration objects during the same build process, a separate build process for printing calibration objects may be obviated. Thus, the effect of the calibration to the normal operation of the 3D printing system 100 may be reduced.

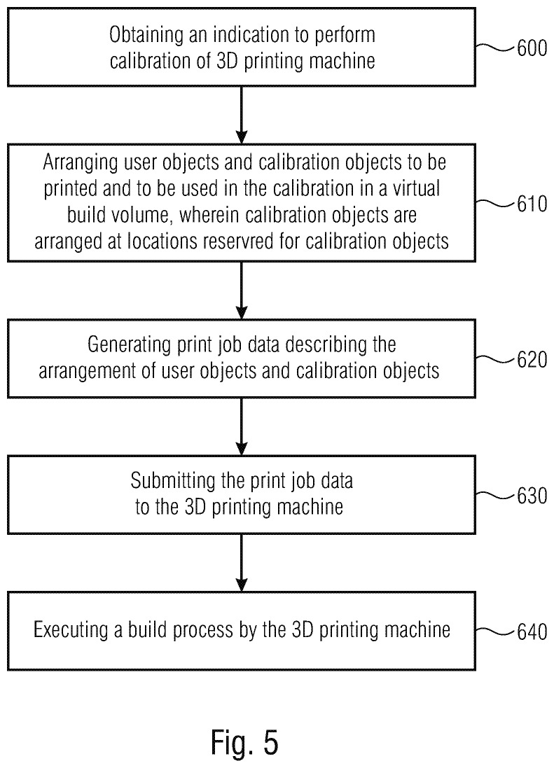

FIG. 5 shows a flow diagram of an example of a method of operating a 3D printing system. At 600 an indication to perform a calibration of the 3D printing machine 140 is obtained. This indication may be triggered by a calibration period setting as described above. The calibration period setting may be stored in any storage medium of the 3D printing system. Upon obtaining an indication to perform a calibration a user may be informed, such as by raising an alert. The alert may be communicated to the user via the user interface 200.

As shown at 610, user objects 500 to be printed and calibration objects 400 to be printed and to be used in the calibration are arranged in a virtual build volume 300. At 610 arranging the objects in the virtual build volume may comprise arranging the calibration objects 400 at locations reserved for calibration objects. The position(s) of the reserved location(s) may be stored in any storage medium associated with the 3D printing system 100. At 620 print job data are generated. The print job data may include first print data describing the arrangement of user objects in the build volume and second print data describing the arrangement of calibration objects in the build volume.

At 630, the print job data are submitted to the 3D printing machine. The print job data may be generated at the apparatus 110 and may be submitted to the 3D printing machine 140, where the print job data may be processed. In processing the print job data at 640, the calibration objects and the user objects are printed during the same build process. In examples, a number of calibration objects is selected at 610 depending on a level of calibration and calibration objects are arranged in the virtual build volume corresponding to the selected number of calibration objects. By selecting the level of calibration the remaining free space for arranging user objects is controllable. A higher level of calibration implies less remaining free space for user objects.

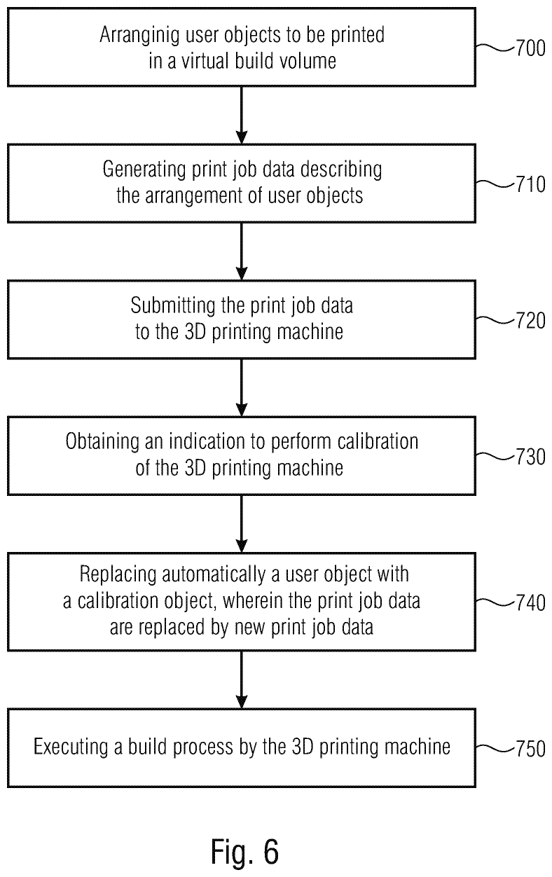

FIG. 6 shows a flow diagram of an example of a method of operating a 3D printing system. At 700 user objects to be printed are arranged in a virtual build volume. The arranging of the user objects may comprise arranging the user objects even at locations actually reserved for calibration objects. As shown in 710, print job data are generated. The print job data may include first print data describing the arrangement of user objects in the build volume and third print data describing the arrangement of user objects in the build volume.

At 720, the print job data are submitted to the 3D printing machine. The print job data may be generated at the apparatus 110 and may be submitted to the 3D printing machine 140, where the print job data may be processed. At 730 an indication to perform a calibration of the 3D printing machine may be obtained. This indication may be triggered by a calibration period setting as described above. The calibration period setting may be stored in any storage medium of the 3D printing system. Upon obtaining an indication to perform a calibration a user may be informed, such as by raising an alert. The alert may be communicated to the user via the user interface 200. The user may then decide, if he wants to perform the calibration of the 3D printing machine with the current print job.

At 740, after affirmation of performing the calibration user objects are replaced automatically with calibration objects. This may be done if there are not any locations reserved for calibration objects or if locations reserved for calibration objects are occupied by user objects. Replacing user objects with calibration objects may comprise generating new print job data. The new print job data may include first print data describing the arrangement of user objects in the build volume and second print data describing the arrangement of calibration objects in the build volume, as indicated at 740.

In processing the new print job data at 750, the calibration objects and the user objects are printed during the same build process. In examples, a number of calibration objects is selected to be replaced automatically in 740 depending on a level of calibration and calibration objects are arranged in the virtual build volume corresponding to the selected number of calibration objects. By selecting the level of calibration the remaining free space for arranging user objects is controllable. A higher level of calibration implies less remaining free space for user objects.

In case the user decides at 730 not to perform a calibration, the method continues directly with the execution of the print job data and the user objects are printed according to the print job data described at 710.

In examples, the method may further comprise measuring a property of the printed calibration objects and updating a calibration model using the measured property. The property measured may be indicative of a behavior of geometric transformation of the calibration objects. The property may be a dimension or dimensions of a feature or features of the calibration object over time. The calibration model may be updated using the measured property.

In examples, the method may further comprise identifying regions of the virtual build volume associated with the 3D printing machine 140 where calibration objects are to be printed. This may be done automatically or by a user. This may allow a user to control at which regions of the printing zone, i.e. the build volume, calibration is to be done. This may allow improving print quality in regions, in which the print quality does not meet the user's expectation.

In examples, the method may further comprise providing a user interface permitting a user to identify the regions of the virtual build volume where calibration objects are to be printed. The user interface may comprise a display with a touchscreen, a keyboard or any other appropriate interface, such as a microphone. The user interface may permit the user to control if, when and where a calibration is to be performed. Furthermore, the user interface may permit the user to determine the level of calibration. Since the user may control if, when and where a calibration is performed, superfluous calibrations and consumption of build material associated with superfluous calibration may be avoided.

Examples provide a non-transitory machine-readable storage medium encoded with instructions executable by a processor. The instructions cause the processor to, upon obtaining an indication that a calibration of a 3D printing machine is to be performed, arrange user objects to be printed and calibration objects to be printed and to be used in the calibration in a virtual build volume. Arranging calibration objects in the virtual build volume comprises arranging the calibration objects 400 at locations reserved for calibration objects and/or replacing user objects with calibration objects.

In examples, the non-transitory machine-readable storage medium may be encoded with instructions so that the methods or parts of the methods as described herein are performed and/or so that the functionalities or part of the functionalities of the hardware described herein are achieved.

In examples of the present disclosure, when a calibration alert is raised, there are two possibilities to perform a calibration. The first way is to reserve zones to print calibration objects and the second way is to automatically replace user objects, i.e. user objects, with calibration objects, i.e. calibration objects.

In examples, in the first possibility, when a user is going to prepare a job for a printer which has the calibration alert raised, a pre-print application may ask the user if he wants to perform the re-calibration, also allowing the user to choose the level of re-calibration he wants to do, such as low, medium or high. Obviously, a higher level of re-calibration implies less space for user objects. In case the user requests to perform the calibration from the pre-print application, then the pre-print application may query to a printer web service to request positions at which a calibration object or calibration objects are to be printed in this job. Then, the printer or the printer web service may respond with a list of bounding boxes of the objects that are to be added, and the pre-print application may prevent the user from placing objects which intersect these boxes. When the print job is fully prepared, the resulting build file, such as a 3MF file, may be sent to the printer specifying in the print job data that it includes the calibration object or the calibration objects. Then, when the job is processed in the printer, using the print job data the printer adds the calibration objects to the reserved positions. Finally, when the job is submitted to be printer, the printer may validate that the job contains calibration objects and may remove the alert.

In examples, in the second possibility, user objects are automatically replaced with calibration objects. If the calibration alert is raised and a user submits a print job which does not include calibration objects, the printer may show a modal dialog before starting the printing operation. In the modal dialog, the user is asked whether he wants to replace some of the objects of the job by calibration objects. Depending on a re-calibration level chosen by the user, more or less objects may be removed. If the user selects to print calibration objects, then some positions may be selected to place the calibration objects, and all objects which intersect with the bounding box of the calibration objects will be removed from the job. The printer may then report the list of objects removed from the job to the user so that the user may prepare a following print job including the removed objects.

In examples, different policies for removing user objects may be used. This may be done periodically. In other examples, at any time there also will be the possibility for the user to manually trigger a calibration by requesting the addition of calibration objects to the user's print job. In examples, the user may identify some zones of the printer's printable box, i.e. the build chamber, where the dimensional accuracy of the printed objects is getting worse over time. Then, using a pre-print application it may be requested to include calibration objects in the zones the user has identified as having poor dimensional accuracy, while the rest of the printable build chamber may still be used for printing the user objects. Once the job is processed by the printer including the calibration objects and submitted to be printed, the printer may detect that the job contains calibrations objects and may reset the calibration alert timer.

A new calibration model may be generated using measured properties of the printed calibration objects. The calibration objects may be used to locally improve the calibration model in the positions where calibration objects were printed. If the new model generated using the calibration objects does not correspond to the original model, the pre-print application may ask to print a calibration bucket, with the objective to recalibrate the calibration model especially to the user's printer. This may be the case where there is a high divergence between the measured properties and the properties which the calibration model originally had. In such case the calibration model may be invalidated and a full calibration job may be executed. The full calibration job may include no other objects than calibration objects.

Examples of the present disclosure permit re-calibration for dimensional accuracy of a printer and, in particular, to correct for thermal non-uniformities across a real build chamber in an easy manner. Examples permit that a user still prints user objects while printing calibration objects. Examples offer the user the capability of identifying zones with poor dimensional accuracy and proactively triggering calibration objects in that zone. Examples provide the flexibility to include calibration objects in advance via a pre-print application or to include calibration objects inside the printer.

Examples described herein may be realized in the form of hardware, machine-readable instructions or a combination of hardware and machine-readable instructions. Any such machine-readable instructions may be stored in the form of volatile or non-volatile storage such as, for example, a storage device, such as a ROM, whether erasable or rewritable or not, or in the form of memory, such as, for example, RAM, memory chips, device or integrated circuits or an optically or magnetically readable medium, such as, for example, a CD, DVD, magnetic disk or magnetic tape. The above storage devices and storage media are examples of storage medium 130 and are examples of machine-readable storage, that are suitable for storing a program or programs that, when executed, implement examples described herein.

In examples, any hardware described herein, in particular the processor, may include circuitry in a controller, a microprocessor, or an application specific integrated circuit, ASIC, or may be implemented with discrete logic or components, or a combination of other types of analog or digital circuitry, combined on a single integrated circuit or distributed among multiple integrated circuits. A product, such as a computer program product, may include a storage medium and computer readable instructions stored on the medium, which when executed in a computer system, a printer or other device, cause the device to perform operations according to any of the description above.

The processing capability of the systems, devices, and circuitry described herein, including the processor 120 or any portion thereof, may be distributed among multiple system components, such as among multiple processors and memories, which may include multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs and applications may be parts, such as subroutines of a single program, separate programs, distributed across several memories and processors, or implemented in many different ways, such as in a library, such as a shared library, such as a dynamic link library, DLL. The DLL, for example, may store code that performs any of the system processing described above. While various examples have been described above, many more implementations are possible.

All of the features disclosed in the specification including any accompanying claims, abstract and drawings, and/or all the features of any method or progress described may be combined in any combination including any claim combination, except combinations where at least some of such features are mutually exclusive. In addition, features disclosed in connection with a system may, at the same time, present features of a corresponding method, and vice versa.

Each feature disclosed in the specification including any accompanying claims, abstract and drawings may be replaced by other features serving the same, equivalent or a similar purpose, unless expressly stated otherwise. Thus, unless expressly stated otherwise, each feature disclosed is one example of a generic series of equivalent or similar features.

The foregoing has described the principles, examples and modes of operation. However, the teachings herein are not be construed as being limited to the particular examples described. The above-described examples are to be regarded as illustrative rather than restrictive, and it is to be appreciated that variations may be made in those examples by workers skilled in the art without departing from the scope of the following claims.

1. An apparatus comprising:
a processor;
a machine-readable storage medium storing machine-readable instructions executable by the processor, the machine-readable instructions comprising instructions to cause the processor to:
upon obtaining an indication that a calibration of a 3D printing machine is to be performed, arrange user objects to be printed and calibration objects to be printed and to be used in the calibration in a virtual build volume, wherein arranging calibration objects in the virtual build volume comprises arranging the calibration objects at print job specific locations reserved for calibration objects and/or replacing a user object with a calibration object.

2. The apparatus of claim 1, wherein the machine-readable instructions are to cause the processor to
generate print job data describing the arrangement of user objects and calibration objects in the virtual build volume; and
submit the print job data to the 3D printing machine.

3. The apparatus of claim 1, wherein the machine-readable instructions comprise instructions to cause the processor to select a number of calibration objects depending on a level of calibration and to arrange the calibration objects corresponding to the selected number of calibration objects in the virtual build volume.

4. The apparatus of claim 1, wherein the machine-readable instructions comprise instructions to cause the processor to identify regions of the virtual build volume where calibration objects are to be arranged to be different from regions of the virtual build volume at which calibration objects have been arranged in a previous calibration of the 3D printing machine.

5. The apparatus of claim 1, wherein the machine-readable instructions comprise instructions to cause the processor to identify regions of the virtual build volume, in which a print quality is reduced.

6. The apparatus of claim 1 comprising a user interface, the user interface to permit a user to:
decide whether calibration of the 3D printing machine is to be performed; and/or
select a level of calibration; and/or
identify regions of the virtual build volume where calibration objects are to be printed.

7. The apparatus of claim 1, wherein the processor is to obtain the indication that the calibration is to be performed dependent on a calibration period setting associated with the 3D printing machine.

8. A 3D printing system comprising a 3D printing machine and the apparatus of claim 1, wherein the 3D printing machine is to execute a build process to print the user objects and the calibration objects during the same build process.

9. A method, comprising:
obtaining an indication that a calibration of a 3D printing machine is to be performed, arranging user objects to be printed and calibration objects to be printed and to be used in the calibration in a virtual build volume, wherein the calibration objects are arranged in the virtual build volume at locations reserved for calibration objects and/or the calibration objects replace user objects, wherein the locations reserved for calibration objects may vary from print job to print job.

10. The method according to claim 9, comprising:
generating print job data describing the arrangement of user objects and calibration objects in the virtual build volume; and
submitting the print job data to the 3D printing machine.

11. The method according to claim 10, further comprising:
executing a build process by the 3D printing machine using the print job data to form the user objects and the calibration objects during the same build process.

12. The method of claim 9, further comprising selecting a number of calibration objects depending on a level of calibration and arranging calibration objects corresponding to the selected number of calibration objects in the virtual build volume.

13. The method of claim 9, comprising providing a user interface permitting a user to decide whether calibration of the 3D printing machine is to be performed.

14. The method of claim 13, comprising providing the user interface permitting a user to select a level of calibration.

15. The method of claim 13, comprising providing the user interface permitting a user to identify the regions of the printing zone of the 3D printing machine where calibration objects are to be printed.
